(19) United States
(12) Patent Application Publication
(10) Pub. No.: US 2024/0380500 A1
(43) Pub. Date: Nov. 14, 2024

(54) METHOD AND APPARATUS FOR PERFORMING PACKET DETECTION BY JOINTLY CONSIDERING MULTIPLE PARAMETERS DERIVED FROM SIGNAL STRENGTH OF RECEIVED SIGNAL

(71) Applicant: Airoha Technology Corp., Hsinchu City (TW)

(72) Inventors: Jeng-Hong Chen, Manhattan Beach, CA (US); Yun-Xuan Zhang, Taipei City (TW); Yun-Ju Chan, New Taipei City (TW)

(73) Assignee: Airoha Technology Corp., Hsinchu City (TW)

(21) Appl. No.: 18/531,707

(22) Filed: Dec. 7, 2023

Related U.S. Application Data
(60) Provisional application No. 63/465,891, filed on May 12, 2023.

(51) Int. Cl. H04B 17/318

(52) U.S. Cl. CPC H04B 17/318

(57) ABSTRACT

A wireless communication method includes: deriving a first received signal at a target channel from a first radio-frequency (RF) signal received through a first antenna; deriving a plurality of different parameters from signal strength of the first received signal; and performing a first packet detection operation for detecting if a packet is included in the first received signal by jointly considering the plurality of different parameters of the first received signal.

### CROSS REFERENCE TO RELATED APPLICATIONS

This application claims the benefit of U.S. Provisional Application No. 63/465, 891, filed on May 12, 2023. The content of the application is incorporated herein by reference.

### BACKGROUND OF THE INVENTION

### 1. Field of the Invention

The present invention relates to wireless communications, and more particularly, to a method and apparatus for performing packet detection by jointly considering multiple parameters derived from signal strength of a received signal.

### 2. Description of the Prior Art

In a wireless communication environment, the signals that transfer through it are very susceptible to changing in amplitude and phase due to many factors such as multipath loss which leads to phenomenon called fading. Fading refers to the fluctuations in signal strength when received at the receiver and multipath fading (also called channel effect) is a common phenomenon that occurs in wireless signal transmission. In a wireless communication system such as a Bluetooth (BT) system, an antenna switch method may be used to avoid or mitigate the channel effect. However, this method requires an extra antenna switching time and a fast and accurate packet detection algorithm. In the future, a BT system may employ Wake-up Radio (WuR) for reducing the power consumption. Similarly, a BT system with WuR also needs a fast and accurate packet detection algorithm. One typical packet detection algorithm may rely on receive signal strength indication (RSSI) measurement. However, multipath fading (also called channel effect) has an impact on the RSSI measurement.

Another typical packet detection algorithm may perform correlation between an access code of a BT packet and a bit sequence of a received signal. In general, the longer correlation time, the better performance to detect the existence of a packet. Since the access code of a BT packet is immediately followed by payload of the BT packet, the packet detection timing is too late. When antenna switch is performed in response to the packet detection result, the following payload will be destroyed by switching of antennas. Furthermore, the correlation-based packet detection needs more power consumption and chip area, and is a time-consuming task that needs more computation time.

### SUMMARY OF THE INVENTION

One of the objectives of the claimed invention is to provide a method and apparatus for performing packet detection by jointly considering multiple parameters derived from signal strength of a received signal.

According to a first aspect of the present invention, an exemplary wireless communication method is disclosed. The exemplary wireless communication method includes: deriving a first received signal at a target channel from a first radio-frequency (RF) signal received through a first antenna; deriving a plurality of different parameters from signal strength of the first received signal; and performing a first packet detection operation for detecting if a packet is included in the first received signal by jointly considering the plurality of different parameters of the first received signal.

According to a second aspect of the present invention, an exemplary wireless communication apparatus is disclosed. The exemplary wireless communication apparatus includes a first receive (RX) circuit, a computation circuit, and a decision circuit. The first RX circuit is arranged to receive a first radio-frequency (RF) signal from a first antenna, and derive a first received signal at a target channel from the first RF signal. The computation circuit is arranged to derive a plurality of different parameters from signal strength of the first received signal. The decision circuit is arranged to perform a first packet detection operation for detecting if a packet is included in the first received signal by jointly considering the plurality of different parameters of the first received signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a first wireless communication apparatus according to an embodiment of the present invention.

FIG. 2 is a diagram illustrating mean values of the signal strength of received signals at different channels in a given specific period of time under a condition that a packet is present at the target channel according to an embodiment of the present invention.

FIG. 3 is a diagram illustrating variance values of the signal strength of received signals at different channels in a given specific period of time under a condition that a packet is present at the target channel according to an embodiment of the present invention.

FIG. 4 is a diagram illustrating mean values of the signal strength of received signals at different channels in a given specific period of time under a condition that no packet is present at the target channel according to an embodiment of the present invention.

FIG. 5 is a diagram illustrating variance values of the signal strength of received signals at different channels in a given specific period of time under a condition that no packet is present at the target channel according to an embodiment of the present invention.

FIG. 6 is a diagram illustrating a second wireless communication apparatus according to an embodiment of the present invention.

FIG. 7 is a diagram illustrating a third wireless communication apparatus according to an embodiment of the present invention.

FIG. 8 is a diagram illustrating an antenna switch procedure employed by a wireless communication apparatus with two antennas according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

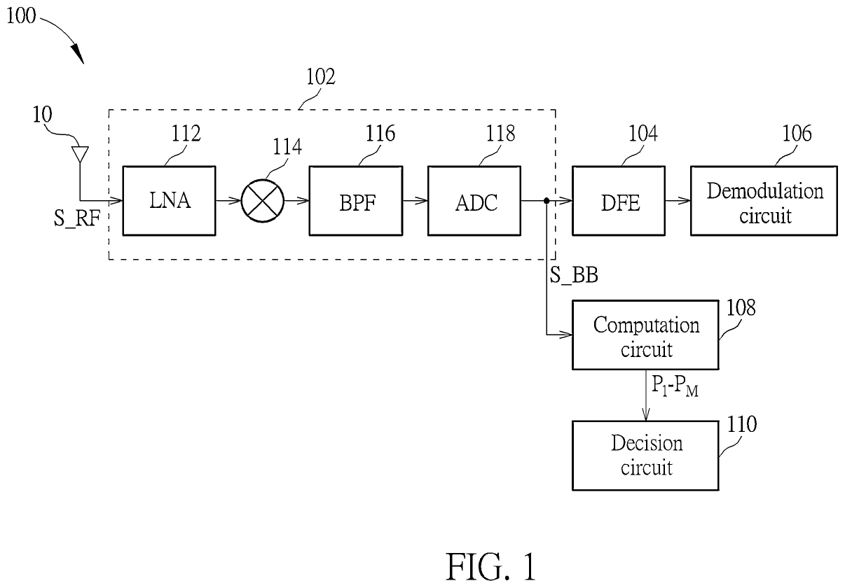

FIG. 1 is a diagram illustrating a first wireless communication apparatus according to an embodiment of the present invention. By way of example, but not limitation, the wireless communication apparatus 100 may be a part of a BT receiver. In practice, the wireless communication apparatus 100 may be employed by any wireless receiver designed for receiving a constant envelope (CE) modulated signal transmitted from a wireless transmitter. As shown in FIG. 1, the wireless communication apparatus 100 includes an antenna 10, a receive (RX) circuit 102, a digital front-end (DFE) 104, a demodulation circuit 106, a computation circuit 108, and a decision circuit 110.

The RX circuit 102 may include a low-noise amplifier (LNA) 112, a mixer 114, a band-pass filter (BPF) 116, and an analog-to-digital converter (ADC) 118. The RX circuit 102 is arranged to receive a radio-frequency (RF) signal S_RF from the antenna 10, and derive a received signal S_BB at a target channel from the RF signal S_RF. In this embodiment, the received signal S_BB is a digital baseband signal output from the ADC 118, and includes a sample sequence xₖ{xₖ, k=0, 1, . . . , N−1} that is used for packet detection, where the number of samples included in the sample sequence xx is equal to N. For example, assuming that the BT signal to be received by the wireless communication apparatus 100 is a Bluetooth Low Energy (BLE) signal with a data rate of 1 megabits per second (Mbps), the ADC 118 may operate at a higher sampling rate to obtain 16 or 32 samples per bit time, i.e., 16 or 32 samples per microsecond (us). In this embodiment, the sample sequence xx may include N samples obtained during one bit time of the BLE signal. Alternatively, the sample sequence xx may include N samples obtained during more than one bit time of the BLE signal. Since the principle of the RX circuit 102 is known by those skilled in the art, further description is omitted here for brevity.

The computation circuit 108 is arranged to derive a plurality of different parameters P₁-P_{M} (M≥2) from signal strength of the received signal S_BB. For example, one of the parameters P₁-P_{M} may be a mean value of the signal strength (e.g., energy or power) of the received signal S_BB, and another of the parameters P₁-P_{M} may be a variance value of the signal strength (e.g., energy or power) of the received signal S_BB. For another example, one of the parameters P₁-P_{M} may be a mean value of the signal strength (e.g., energy or power) of the received signal S_BB, and another of the parameters P₁-P_{M} may be a standard deviation value (or normalized variance value) of the signal strength (e.g., energy or power) of the received signal S_BB. The decision circuit 110 is arranged to perform a packet detection operation for detecting if a packet is included in the received signal S_BB by jointly considering the different parameters P₁-P_{M} of the received signal S_BB.

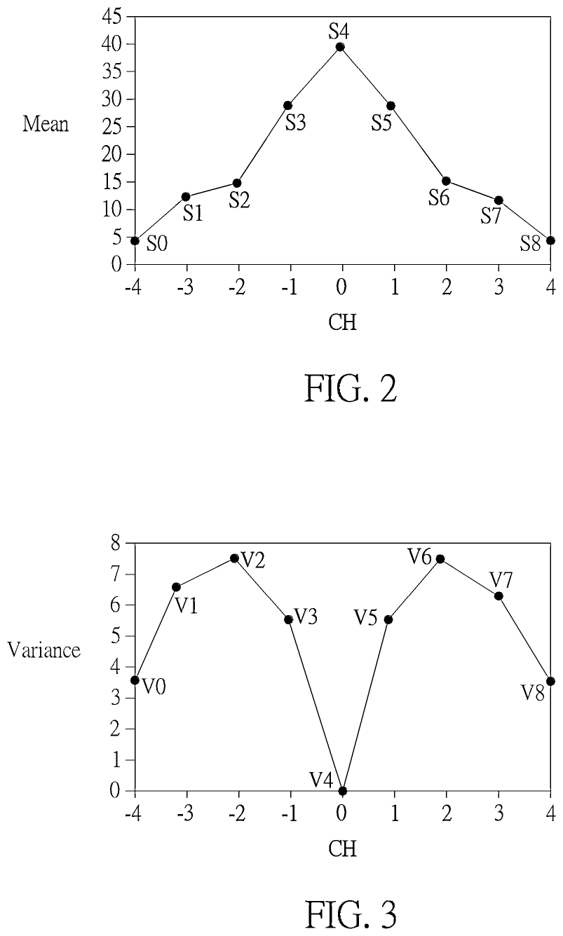

The BLE signal is a Gaussian frequency-shift keying (GFSK) modulated signal. Hence, the BLE signal is a CE modulated signal. The present invention leverages inherent characteristics of the CE modulation to achieve ultra-fast packet detection. Please refer to FIG. 2 and FIG. 3. FIG. 2 is a diagram illustrating mean values of the signal strength of received signals at different channels in a given specific period of time under a condition that a packet (e.g., BLE packet) is present at the target channel according to an embodiment of the present invention, where the horizontal axis represents the channel, and the vertical axis represents the mean value. FIG. 3 is a diagram illustrating variance values of the signal strength of received signals at different channels in a given specific period of time under a condition that a packet (e.g., BLE packet) is present at the target channel according to an embodiment of the present invention, where the horizontal axis represents the channel, and the vertical axis represents the variance value.

The target channel (i.e., in-band channel) is represented by CH=0. The non-target channels (i.e., out-of-band channels) include adjacent channels represented by CH=−4, CH=−3, CH=−2, CH=−1, CH=1, CH=2, CH=3, CH=4. Suppose that a packet (e.g., BLE packet) is present at the target channel. The BPF 116 shown in FIG. 1 is tuned to the target channel CH=0 for attenuating signal components at the non-target channels CH=−4, CH=−3, CH=−2, CH=−1, CH=1, CH=2, CH=3, CH=4. Hence, the mean value S4 of the target channel CH=0 is larger than mean values S0, S1, S2, S3, S5, S6, S7, S8 of the non-target channels CH=−4, CH=−3, CH=−2, CH=−1, CH=1, CH=2, CH=3, CH=4.

The CE modulation has one key characteristic that a variance value of the signal strength is theoretically zero. However, if a signal component (e.g., out-of-band signal component) of a CE modulated signal is disrupted during signal processing (e.g., out-of-band interference suppression), the variance value of the signal component is no longer zero, but becomes significantly larger. Since signal components at the non-target channels CH=1, CH=2, CH=3, CH=4, CH=−1, CH=−2, CH=−3, CH=−4 are attenuated/destroyed by BPF 116 shown in FIG. 1, the CE property (which has minimal, or zero variance in theory) is destroyed and the variance value V4 of the target channel CH=0 is smaller than variance values V0, V1, V2, V3, V5, V6, V7, V8 of the non-target channels CH=−4, CH=−3, CH=−2, CH=−1, CH=1, CH=2, CH=3, CH=4. Hence, when a packet (e.g., BLE packet) is present at the target channel CH=0, the mean value S4 is a peak value among mean values S0-S8 of all channels, and the variance value V4 is a valley value among variance values V0-V8 of all channels due to the fact that the CE property is substantially not destroyed on the target channel CH=0. Specifically, when a packet (e.g., BLE packet) is present at the target channel CH=0, the mean value S4 is larger than one predetermined threshold value, and the variance value V4 is smaller than another predetermined threshold value.

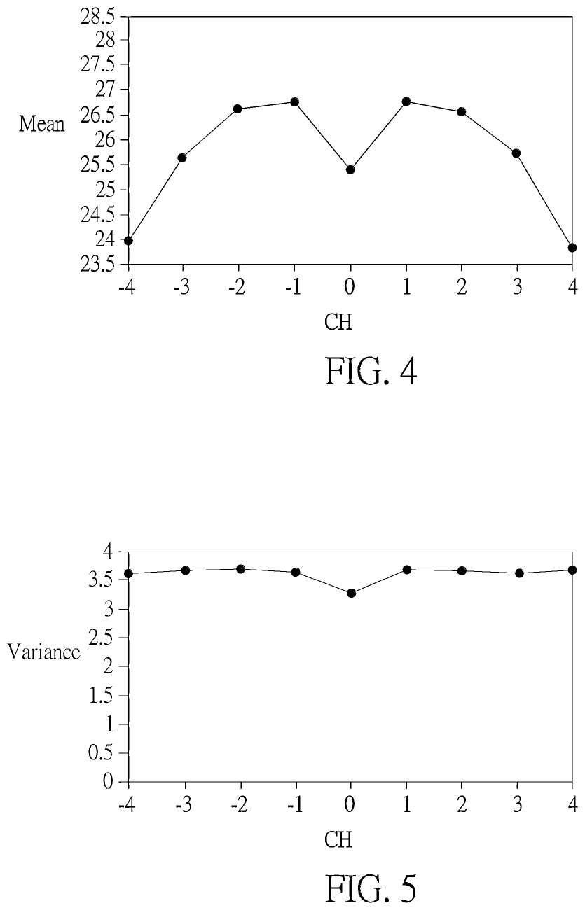

If an interference signal (which is not a CE modulated signal) is present at the target channel (i.e., in-band channel) CH=0, the mean value and the variance value calculated for the target channel do not have such characteristics mentioned above. Please refer to FIG. 4 and FIG. 5. FIG. 4 is a diagram illustrating mean values of the signal strength of received signals at different channels in a given specific period of time under a condition that no packet (e.g., BLE packet) is present at the target channel according to an embodiment of the present invention, where the horizontal axis represents the channel, and the vertical axis represents the mean value. FIG. 5 is a diagram illustrating variance values of the signal strength of received signals at different channels in a given specific period of time under a condition that no packet (e.g., BLE packet) is present at the target channel according to an embodiment of the present invention, where the horizontal axis represents the channel, and the vertical axis represents the variance value.

Suppose that the interference signal is a Wi-Fi signal (which may employ quadrature amplitude modulation (QAM) that is not CE modulation). The mean value calculated for the target channel (i.e., in-band channel) CH=0 used by Wi-Fi transmission is large. However, the variance value calculated for the target channel (i.e., in-band channel) CH=0 used by Wi-Fi transmission is also larger due to the fact that Wi-Fi transmission does not adopt CE modulation. Specifically, because a Wi-Fi signal is not CE modulated, the variance value is relatively large no matter whether the Wi-Fi signal is on the target channel or non-target channels.

Based on above observation, the computation circuit 108 may be arranged to refer to samples of the sample sequence xₖ included in the received signal S_BB (which is a digital baseband signal at the target channel) for calculating an RSSI value as a parameter P₁. For example, when samples of the sample sequence xₖ {xₖ, k=0, 1, . . . , N−1} are sequentially received by the computation circuit 108, the computation circuit 108 may calculate an accumulation value of samples included in the sample sequence xₖ (i.e., Σₖ₌₀^{N-1}|xₖ|) and an accumulation value of squares of samples included in the sample sequence xₖ (i.e., Eₖ₌₀^{N-1}|xₖ|²) for later use, wherein Σₖ₌₀^{N-1} |xₖ|² is deemed as the signal strength in a given period of time. Hence, the RSSI value RSSI₀ (which is a mean value of the signal strength of the received signal S_BB) may be computed using the following formula.

$${RSSI}_{0} = E \{ {\vert {x}_{k} \vert}^{2} \} = \frac{1}{N} {\sum }_{k = 0}^{N - 1} {\vert {x}_{k} \vert}^{2} \qquad ( 1 )$$

In addition, the computation circuit 108 may be arranged to calculate a variance value VAR₀ of the samples of the sample sequence xₖ (i.e., RSSI variance). A second parameter P₂ is derived from at least the variance value VAR₀. The variance value VAR₀ may be computed using the following formula.

$${VAR}_{0} = Var \{ \vert {x}_{k} \vert \} = E \{ {\vert {x}_{k} \vert}^{2} \} - E {\{ \vert {x}_{k} \vert \}}^{2} , where E \{ \vert {x}_{k} \vert \} = \frac{1}{N} {\sum }_{k = 0}^{N - 1} \vert {x}_{k} \vert \qquad ( 2 )$$

In one embodiment, the second parameter P₂ may be set by the variance value VAR₀. In another embodiment, the second parameter P₂ may be set by a normalized variance value EVM₀. The normalized variance value EVM₀ may be computed using the following formula.

$${EVM}_{0} = \frac{{VAR}_{0}}{{RSSI}_{0}} = \frac{Var \{ \vert {x}_{k} \vert \}}{E \{ {\vert {x}_{k} \vert}^{2} \}} \qquad ( 3 )$$

The sample sequence xₖ {xₖ, k=0, 1, . . . , N−1} may include N samples that are obtained from sampling an analog filter output of the BPF 116 during one bit time (e.g., 1 us) of a BLE signal with a data rate of 1 Mbps. It should be noted that the number N of samples used for computing RSSI value RSSI₀, variance value VAR₀, and normalized variance value EVM₀ may be adjusted, depending upon actual design considerations. Since an average operation is involved in computation of RSSI value RSSI₀, variance value VAR₀, and normalized variance value EVM₀, characteristics of the CE modulated signal as illustrated in FIGS. 2-3 are more observable by using the sample sequence xₖ with samples obtained from the received signal S_BB during a shorter period of time. In this way, ultra-fast packet detection can be achieved.

In further detail, in a circumstance where the received signal S_BB is the CE modulated signal accompanied with the noise signal, the variance value of the received signal S_BB is dominated by the noise signal due to the fact that the variance value of the CE modulated signal is zero. Moreover, due to usage of the average operation, the variance value of the noise signal is further reduced to 1/N of its original value, where N is positively correlated to detection time. Conversely, in a circumstance where the received signal S_BB is not the CE modulated signal but still accompanied with the noise signal, the variance value of the received signal S_BB is instead dominated by the non-CE modulated signal, which has a variance value significantly larger than that of the noise signal. In a short period of time, the average operation cannot significantly reduce the variance value of the non-CE modulated signal. As a result, the shorter the detection time the more effectively the CE modulated signal can be distinguished from the non-CE modulated signal, enabling ultra-fast packet detection.

After the parameters P₁ (e.g., P₁=RSSI₀) and P2 (e.g., P₂=VAR₀ or EVM₀) are available, the decision circuit 110 performs a packet detection operation for detecting if a packet (e.g., BLE packet) is included in the received signal S_BB at the target channel by jointly considering the parameters P₁ (e.g., P₁=RSSI₀) and P₂ (e.g., P₂=VAR₀ or EVM₀). For example, the decision circuit 110 may check if the parameter P₁ (e.g., P₁=RSSI₀) is larger than one threshold value TH0 and the parameter P2 (e.g., P₂=VAR₀ or EVM₀) is lower than another threshold value TH1. When the parameter P₁(e.g., P₁=RSSI₀) is found larger than the threshold value TH0 and the parameter P2 (e.g., P₂=VAR₀ or EVM₀) is found lower than the threshold value TH1, the decision circuit 110 determines that a packet is detected (i.e., a packet is present at the received signal S_BB). When the parameter P₁ (e.g., P₁=RSSI₀) is not found larger than the threshold value TH0 or the parameter P2 (e.g., P₂=VAR₀ or EVM₀) is not found lower than the threshold value TH1, the decision circuit 110 determines that no packet is detected (i.e., no packet is present at the received signal S_BB).

In the above embodiment, only the parameters P₁ (e.g., P₁=RSSI₀) and P2 (e.g., P₂=VAR₀ or EVM₀) derived from signal strength of the received signal S_BB at the target channel are jointly considered for packet detection of the target channel. However, this is for illustrative purposes only, and is not meant to be a limitation of the present invention. In an alternative design, parameters derived from signal strength of other received signal(s) at non-target channel(s) may also be jointly considered for packet detection of the target channel.

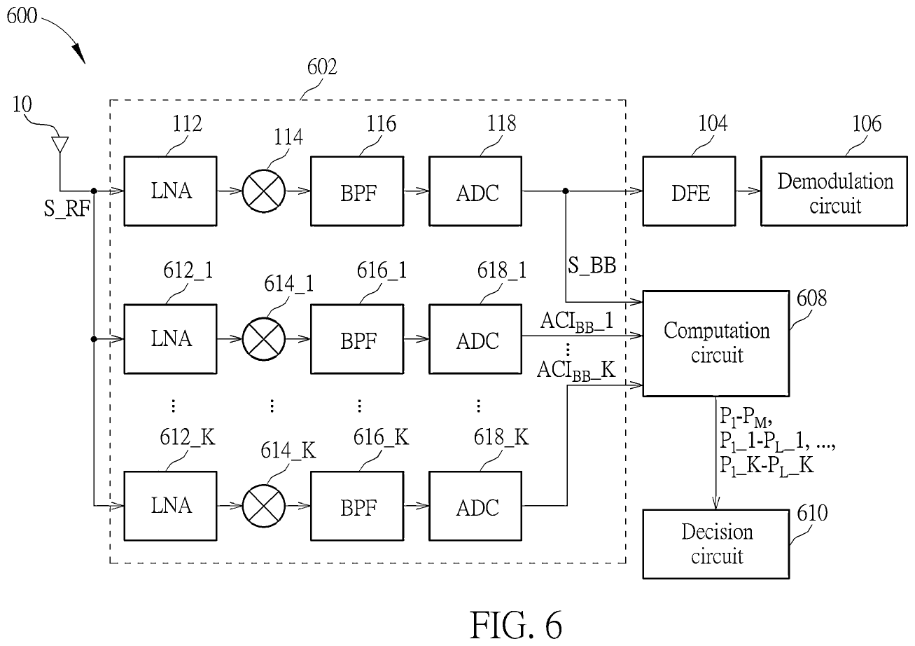

FIG. 6 is a diagram illustrating a second wireless communication apparatus according to an embodiment of the present invention. By way of example, but not limitation, the wireless communication apparatus 600 may be a part of a BT receiver. In practice, the wireless communication apparatus 600 may be employed by any wireless receiver designed for receiving a CE modulated signal transmitted from a wireless transmitter. The major difference between the wireless communication apparatuses 600 and 100 is that the RX circuit 602 includes multiple RX chains. Hence, the RX circuit 602 further includes LNAs 612_1-612_K (K≥1), mixers 614_1-614_K (K≥1), BPFs 616_1-616_K (K≥1), and ADCs 618_1-618_K (K≥1). An RX chain includes a LAN, a mixer, a BPF, and an ADC.

In addition to the parameters P₁-P_{M} of the target channel, the computation circuit 608 further generates parameters P₁_1-P_{L}_1, . . . , P₁_K-P_{L}_K (L≥1 & K≥1) for received signals ACI_{BB}_1-ACI_{BB}_K (K≥1) at non-target channel(s). The decision circuit 610 performs a packet detection operation for detecting if a packet is included in the received signal S_BB at the target channel by jointly considering parameters P₁-P_{M} of the target channel and parameters P₁_1-P_{L}_1, . . . , P₁_K-P_{L}_K of non-target channel(s).

Taking the generation of parameters P₁_1-P_{L}_1for example, the RX circuit 602 (particularly, LNA 612_1, mixer 614_1, BPF 616_1 and ADC 618_1 of RX circuit 602) derives a received signal ACI_{BB}_1 (which is a digital baseband signal) at a non-target channel (which is an adjacent channel of the target channel) from the RF signal S_RF received through the antenna 10, and the computation circuit 608 derives one or more parameters P₁_1-P_{L}_1 (L≥1) from signal strength of the received signal ACI_{BB}_1. For example, one of the parameters P₁_1-P_{L}_1 may be a mean value of the signal strength (e.g., energy or power) of the received signal ACI_{BB}_1, and another of the parameters P₁_ 1-P_{L}_1 may be a variance value of the signal strength (e.g., energy or power) of the received signal ACI_{BB}_1. For another example, one of the parameters P₁_1-P_{L}_1 may be a mean value of the signal strength (e.g., energy or power) of the received signal ACI_{BB}_1, and another of the parameters P₁_1-P_{L}_1 may be a standard deviation value (or normalized variance value) of the signal strength (e.g., energy or power) of the received signal ACI_{BB}_1. The mean value of the signal strength of the received signal ACI_{BB}_1 may be computed using the aforementioned formula (1). The variance value of the signal strength of the received signal ACI_{BB}_1 may be computed using the aforementioned formula (2). The normalized variance value of the signal strength of the received signal ACI_{BB}_1 may be computed using the aforementioned formula (3).

In addition to the parameters P₁-P_{M} of the received signal S_BB at the target channel, the proposed packet detection design also checks parameter(s) of received signal(s) ACI_{BB}_1-ACI_{BB}_K (K≥1) at non-target channel(s). In this way, the packet detection accuracy can be improved due to more useful information provided from non-target channel(s).

Considering a case where the mean value (RSSI value) S4 of the target channel CH=0, additional mean values (RSSI values) S3 and S5 of the non-target channels CH=−1 and CH=1, and the (normalized) variance value V4 of the target channel CH=0 are generated by the computation circuit 608 and provided to the decision circuit 610, the decision circuit 610 may check if these conditions {(S4-S3)>thu1&&(S4-S5)>thu1&&(V4-0)<thuv1} are met, to determine if a packet is present at the received signal S_BB at the target channel CH=0, where the threshold values thu1 and thuv1 may be set by experiment or simulation.

Considering another case where the mean value (RSSI value) S4 of the target channel CH=0, additional mean values (RSSI values) S0, S1, S2, S3, S5, S6, S7, S8 of the non-target channels CH=−4, CH=−3, CH=−2, CH=−1, CH=1, CH=2, CH=3, and CH=4, the (normalized) variance value V4 of the target channel CH=0, and additional (normalized) variance values V0-V3 and V4-V8 of the non-target channels CH=−4, CH=−3, CH=−2, CH=−1, CH=1, CH=2, CH=3, and CH=4 are generated by the computation circuit 608 and provided to the decision circuit 610, the decision circuit 610 may check if these conditions {(S4-S3)>thu1 && (S4-S5)>thu1 && (S3-S2)>thu2 && (S5-S6)>thu2 && (S4-S2)>thu3 && (S4-S6)>thu3 && S1<thd1 && S7<thd1 && SO<thd2 && S8<thd₂ && (V4-0)<thuv1 && both V3 and V5>thuv2 && both V2 and V6>thuv3&& (V2-V3)>thuv4 && (V6-V5)>thuv4&& (V2-V1)>thuv5&& (V6-V7)>thuv5} are partially or all met, to determine if a packet is present at the received signal S_BB at the target channel CH=0, where the threshold values thu1, thu2, thu3, thd1, thd2, thuv1, thuv2, thuv3, thuv4, and thuv5 may be set by experiment or simulation.

In a wireless communication system such as a BT system, an antenna switch method may be used to avoid or mitigate the channel effect. In some embodiments of the present invention, the proposed packet detection method may be integrated with an antenna switch method for selecting a target antenna (i.e., best antenna) among multiple antennas.

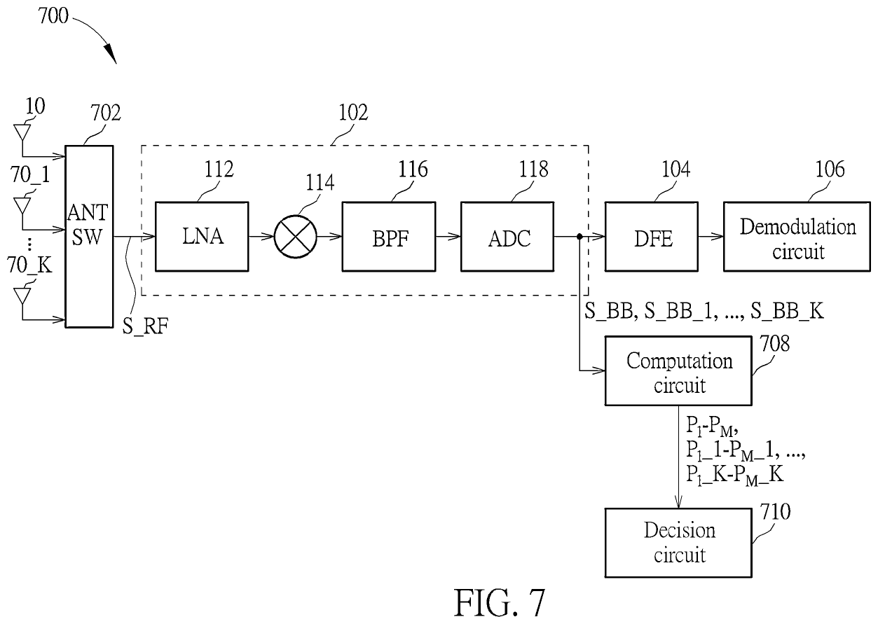

FIG. 7 is a diagram illustrating a third wireless communication apparatus according to an embodiment of the present invention. By way of example, but not limitation, the wireless communication apparatus 700 may be a part of a BT receiver. In practice, the wireless communication apparatus 700 may be employed by any wireless receiver designed for receiving a CE modulated signal transmitted from a wireless transmitter. The major difference between the wireless communication apparatuses 700 and 100 is that the wireless communication apparatus 700 further includes an antenna switch circuit (labeled by “ANT SW”) 702 and one or more additional antennas 70_1-70_K (K≥1), wherein the antenna switch circuit 702 is arranged to couple one of the multiple antennas 10 and 70_1-70_K to the RX circuit 102. Hence, when the antenna 10 is selected by the antenna switch circuit 702, the RX circuit 102 receives the RF signal S_RF from the antenna 10, and derives a received signal S_BB at the target channel from the RF signal S_RF; when the antenna 70_1 is selected by the antenna switch circuit 702, the RX circuit 102 receives the RF signal S_RF from the antenna 70_1, and derives a received signal S_BB_1 at the same target channel (i.e., a target channel that is the same as the target channel from which the received signal S_BB is derived under a condition that the antenna 10 is selected) from the RF signal S_RF; and when the antenna 70_K is selected by the antenna switch circuit 702, the RX circuit 102 receives the RF signal S_RF from the antenna 70_K, and derive a received signal S_BB_K at the same target channel (i.e., a target channel that is the same as the target channel from which the received signal S_BB is derived under a condition that the antenna 10 is selected) from the RF signal S_RF.

In addition to different parameters P₁-P_{M} (M≥2) that are derived from signal strength of the received signal S_BB, the computation circuit 708 is further arranged to derive different parameters P₁_1-P_{M}_1 from signal strength of the received signal S_BB_1, and different parameters P₁_K-P_{M}_K from signal strength of the received signal S_BB_K. For example, one of the parameters P₁_1-P_{M}_1 (P₁_K-P_{M}_K) may be a mean value of the signal strength (e.g., energy or power) of the received signal S_BB_1 (S_BB_K), and another of the parameters P₁_1-P_{M}_1 (P₁_K-P_{M}_K) may be a variance value of the signal strength (e.g., energy or power) of the received signal S_BB_1 (S_BB_K). For another example, one of the parameters P₁_1-P_{M}_1 (P₁_K-P_{M}_K) may be a mean value of the signal strength (e.g., energy or power) of the received signal S_BB_1 (S_BB_K), and another of the parameters P₁_1-P_{M}_1 (P₁_K-P_{M}_K) may be a standard deviation value (or normalized variance value) of the signal strength (e.g., energy or power) of the received signal S_BB_1 (S_BB_K). The mean value of the signal strength of the received signal S_BB_1 (S_BB_K) may be computed using the aforementioned formula (1). The variance value of the signal strength of the received signal S_BB_1 (S_BB_K) may be computed using the aforementioned formula (2). The normalized variance value of the signal strength of the received signal S_BB_1 (S_BB_K) may be computed using the aforementioned formula (3).

The decision circuit 710 is further arranged to perform a packet detection operation for detecting if a packet is included in the received signal S_BB_1 by jointly considering the different parameters P₁_1-P_{M}_1 of the received signal S_BB_1. Similarly, the decision circuit 710 is further arranged to perform a packet detection operation for detecting if a packet is included in the received signal S_BB_K by jointly considering the different parameters P₁_K-P_{M}_K of the received signal S_BB_K.

Since the wireless communication apparatus 700 is equipped with multiple antennas 10 and 70_1-70_K (K≥1), the decision circuit 710 may select a best antenna from all available antennas according to parameters provided from the computation circuit 708.

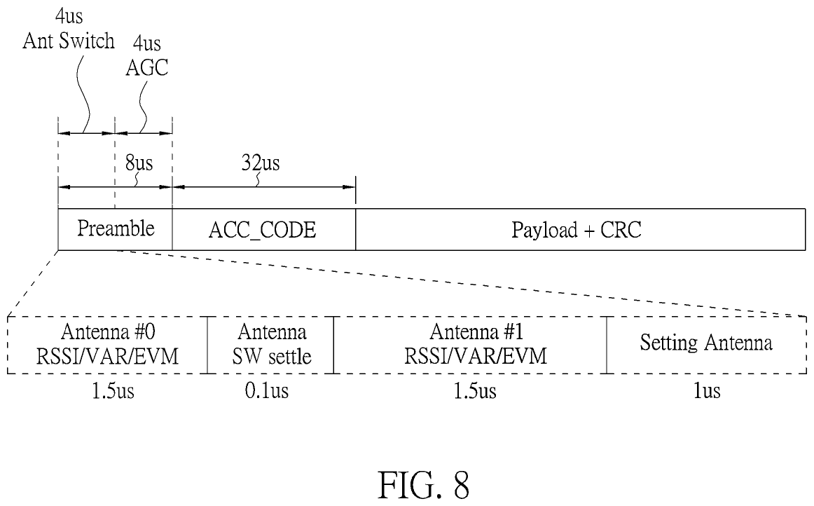

FIG. 8 is a diagram illustrating an antenna switch procedure employed by a wireless communication apparatus with two antennas according to an embodiment of the present invention. One BT packet may include a preamble, an access code (labeled by “ACC_CODE”), and a payload with cyclic redundancy check (CRC). A first part of the preamble can be used for packet detection as well as antenna switch. A second part of the preamble can be used for automatic gain control (AGC).

Suppose that the wireless communication apparatus 700 has two antennas 10 and 70_1 (K=1). When the antenna switch procedure starts, the antenna switch circuit 702 is controlled to first select one of the antennas 10 and 70_1 for allowing the computation circuit 708 to compute parameters needed by the decision circuit 710, and then controlled to select another of the antennas 10 and 70_1 for allowing the computation circuit 708 to compute other parameters needed by the decision circuit 710. Hence, the decision circuit 710 selects a target antenna (i.e., best RX antenna) from multiple antennas 10 and 70_1 according to parameters P₁-P_{M} of the received signal S_BB and parameters P₁_1-P_{M}_1 of the received signal S_BB_1. Specifically, the decision circuit 710 performs a comparison operation according to parameters P₁-P_{M} of the received signal S_BB (e.g., RSSI₀ and VAR₀, or RSSI₀ and EVM₀) and parameters P₁_1-P_{M}_1 of the received signal S_BB_1 (e.g., RSSI₁ and VAR₁, or RSSI₁ and EVM₁), and selects the target antenna from multiple antennas 10 and 70_1 according to comparison results. For example, the decision circuit 710 may select an antenna which has a smaller (or minimum) EVM value from antennas 10 and 70_1 if both conditions {RSSI₀>TH_High && RSSI₁>TH_High} are met, where the threshold value TH_High may be set by experiment or simulation. For another example, the decision circuit 710 may select an antenna which has a smaller (or minimum) EVM value from antennas 10 and 70_1 if both conditions {|RSSI₀-RSSI₁|<TH_0 && |EVM₀-EVM₁|>TH_1} are met, where the threshold values TH_0 and TH_1 may be set by experiment or simulation. For yet another example, the decision circuit 710 may select an antenna which has a smaller (or minimum) EVM value from antennas 10 and 70_1 if both conditions RSSI₀>TH_High && RSSI₁>TH_High are met. If the conditions {RSSI₀>TH_High && RSSI₁>TH_High} are not met, the decision circuit 710 may select an antenna which has a smaller (or minimum) EVM value from antennas 10 and 70_1 if both conditions {|RSSI₀-RSSI₁|<TH_0&& |EVM₀-EVM₁|>TH_1} are met.

Compared to a typical method which uses an access code for packet detection, the proposed method starts the packet detection before a start of the access code (i.e., before an end of the preamble). Since switching of antennas occurs much earlier than a start of the payload, data carried by the payload are protected from being destroyed by the antenna switch operation used to avoid or mitigate the channel effect. In addition, the proposed method performs packet detection by using power/energy detection rather than access code correction, power consumption, chip area and processing time can be effectively reduced. Furthermore, the proposed method can monitor CE characteristics (e.g., RSSI and RSSI variance) of multiple channels, including a target channel and at least one non-target channel, to get a more accurate packet detection result. The characteristics of a CE modulated signal are more observable from parameters computed using a sample sequence with samples obtained from a received signal during a shorter period of time. Hence, the proposed method can get the accurate packet detection result in a very short period of time, and can be applicable to any wireless communication apparatus that needs fast and accurate packet detection. For example, the wireless communication apparatus 100/600/700 may be a WuR receiver that requires fact and accurate packet detection.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A wireless communication method comprising:
deriving a first received signal at a target channel from a first radio-frequency (RF) signal received through a first antenna;
deriving a plurality of different parameters from signal strength of the first received signal; and
performing a first packet detection operation for detecting if a packet is included in the first received signal by jointly considering the plurality of different parameters of the first received signal.

2. The wireless communication method of claim 1, wherein deriving the plurality of different parameters from the signal strength of the first received signal comprises:
referring to a plurality of samples of the first received signal for calculating a receive signal strength indication (RSSI) value as a first parameter included in the plurality of different parameters.

3. The wireless communication method of claim 2, wherein deriving the plurality of different parameters from the signal strength of the first received signal further comprises:
calculating a variance value of the plurality of samples, wherein a second parameter included in the plurality of different parameters is derived from at least the variance value.

4. The wireless communication method of claim 3, wherein deriving the plurality of different parameters from the signal strength of the first received signal further comprises:
dividing the variance value by the RSSI value to generate a normalized variance value as the second parameter.

5. The wireless communication method of claim 1, further comprising:
deriving a second received signal at a non-target channel from the first RF signal; and
deriving at least one parameter from signal strength of the second received signal;
wherein performing the first packet detection operation for detecting if the packet is included in the first received signal comprises:
jointly considering the plurality of different parameters of the first received signal and the at least one parameter of the second received signal.

6. The wireless communication method of claim 1, further comprising:
deriving a second received signal at the target channel from the RF signal received through a second antenna;
deriving a plurality of different parameters from signal strength of the second received signal; and
performing a second packet detection operation for detecting if a packet is included in the second received signal by jointly considering the plurality of different parameters of the second received signal.

7. The wireless communication method of claim 6, further comprising:
selecting a target antenna from multiple antennas including the first antenna and the second antenna according to parameters including the plurality of different parameters of the first received signal and the plurality of different parameters of the second received signal.

8. The wireless communication method of claim 1, wherein the wireless communication method is employed by a Bluetooth receiver.

9. The wireless communication method of claim 1, wherein the wireless communication method is employed by a Wake-up Radio (WuR) receiver.

10. The wireless communication method of claim 1, wherein the first received signal is a constant envelope (CE) modulated signal.

11. A wireless communication apparatus comprising:
a receive (RX) circuit, arranged to receive a first radio-frequency (RF) signal from a first antenna, and derive a first received signal at a target channel from the first RF signal;
a computation circuit, arranged to derive a plurality of different parameters from signal strength of the first received signal; and
a decision circuit, arranged to perform a first packet detection operation for detecting if a packet is included in the first received signal by jointly considering the plurality of different parameters of the first received signal.

12. The wireless communication apparatus of claim 11, wherein the computation circuit is arranged to refer to a plurality of samples of the first received signal for calculating a receive signal strength indication (RSSI) value as a first parameter included in the plurality of different parameters.

13. The wireless communication apparatus of claim 12, wherein the computation circuit is arranged to calculate a variance value of the plurality of samples, and a second parameter included in the plurality of different parameters is derived from at least the variance value.

14. The wireless communication apparatus of claim 13, wherein the computation circuit is arranged to divide the variance value by the RSSI value to generate a normalized variance value as the second parameter.

15. The wireless communication apparatus of claim 11, wherein the RX circuit is further arranged to derive a second received signal at a non-target channel from the first RF signal; and the computation circuit is arranged to derive at least one parameter from signal strength of the second received signal; and the decision circuit is arranged to perform the packet detection operation by jointly considering the plurality of different parameters of the first received signal and the at least one parameter of the second received signal.

16. The wireless communication apparatus of claim 11, further comprising:
an antenna switch circuit, coupled between multiple antennas and the RX circuit, wherein the antenna switch circuit is arranged to couple one of the multiple antennas to the RX circuit, and the multiple antennas comprise the first antenna and at least a second antenna;
wherein the RX circuit is further arranged to receive the RF signal from the second antenna, and derive a second received signal at the target channel from the second RF signal; the computation circuit is further arranged to derive a plurality of different parameters from signal strength of the second received signal; and the decision circuit is further arranged to perform a second packet detection operation for detecting if a packet is included in the second received signal by jointly considering the plurality of different parameters of the second received signal.

17. The wireless communication apparatus of claim 16, wherein the decision circuit is further arranged to select a target antenna from the multiple antennas according to parameters including the plurality of different parameters of the first received signal and the plurality of different parameters of the second received signal.

18. The wireless communication apparatus of claim 11, wherein the wireless communication apparatus is a part of a Bluetooth receiver.

19. The wireless communication apparatus of claim 11, wherein the wireless communication apparatus is a part of a Wake-up Radio (WuR) receiver.

20. The wireless communication apparatus of claim 11, wherein the first received signal is a constant envelope (CE) modulated signal.
